(19) United States
(12) Patent Application Publication
(10) Pub. No.: US 2003/0222025 A1
(43) Pub. Date: Dec. 4, 2003

(54) Use of foamed glass article for environment remediation and filtration

(76) Inventor: John Paul Archuleta, Santa Fe, NM (US)

Correspondence Address: John Paul Archuleta, c/o/ Aaron Bartels, 3600 Cerillos, #107, Santa Fe, NM, 87507-2613, US

(21) Appl. No.: 10/163,127

(22) Filed: Jun. 4, 2002

(51) Int. Cl. C02F 1/28; E02B 15/04

(52) U.S. Cl. 210/691; 210/799; 210/242.4; 210/510.1; 210/924

(57) ABSTRACT

Methods, systems and devices for environmental remediation utilizing a foamed glass article. A foamed glass article is provided, which can come into contact with a viscous fluid, such as, for example oil or another petroleum based viscous product. The foamed glass article absorbs the viscous fluid in order to prevent further environmental contamination thereof by said viscous fluid. The foamed glass article can be formed in the shape of a block, a disk or a number of other shapes, such as spherical or pyramidal shapes.

### TECHNICAL FIELD

The present invention is generally related to remediation, and filtering systems and devices. In particular the present invention is related to environmental remediation and filtering devices, methods and systems thereof. The present invention is further related to a foamed glass article, such as a block, disc, or other similar product, for environmental remediation and filtration. The present invention is further related to methods and devices for oil spill remediation.

### BACKGROUND OF THE INVENTION

Oil spills have damaged the environment throughout the years. The continuing incidence of oil spillage into both marine and inland waterways due to shipping accidents, for example has resulted in enormous annual costs both financially to the shipping and insurance industries and environmentally. Oil spills also occur in typical commercial and non-commercial settings, such as warehouses, parking lots, gas stations, and home driveways. Oil spills can result in the unwanted and dangerous seepage of oil into the ground, thereby contaminating ground water resources.

Many spill incidents occur in bad weather or in remote locations. Current systems for ameliorating oil spills require that specialized spill-response ships containing unique heavy equipment reach the site of the spill quickly, which requires relatively calm waters. There are a limited number of units of specialized equipment, and they are not easily transported. Thus, in many cases, response to the spill is delayed for many hours or even days. The impact of a spill is greatly increased by both bad weather and delayed response. Spill damage can be mitigated if response is rapid, even in rough-water conditions.

Oil spills are generally treated through physical containment of the spilled oil and removal, using mechanical techniques, such as containment rings and vacuum removal systems. Other means for treating such spills include direct application to the spill of dispersants and application of bioremediation agents, such as aerobic microorganisms, enzymes and nutrients. These methodologies have been used with varying degrees of effectiveness, depending upon many variables, such as the size and depth of the spill, as well as its location and accessibility, the speed with which it develops and travels, the configuration of the spill, whether the spill is at the surface or submerged in the water, the environmental risk to land and sea life, including wildlife, the turbulence of the waters containing the spill, as well as many other factors and considerations. Limited success in adequately dealing with such spills evidences the need for a product and method for dealing with an oil spill promptly, irrespective of its location, configuration and accessibility, with minimum disruption to the environment, in an economical manner, and through use of a universal system, which is not dependent upon the variables of the spill.

The present inventor has recognized that a continuing need exists for environmental remediation systems, methods and devices, which can efficiently remediate and/or filter oil from either water or surfaces, such as concrete. The present inventor has conducted a number of experiments directed at testing the use of foamed glass articles for oil spill remediation (i.e., a type of environmental remediation) and/or oil filtration. In particular, the present inventor has studied a particular type of foamed glass article. Such foamed glass articles have traditionally been utilized for preparing surfaces. To date, however, such foamed glass articles have not been utilized for environmental remediation and filtration. This need has not been recognized by those skilled in the art, because of the focus on surface preparation techniques thereof.

A particular type of foamed glass article is disclosed in U.S. Pat. No. 5,972,817, “Foamed Glass Article for Preparing Surfaces, Use Therefor, and Method of Making Same” to Haines et al., which issued on Oct. 26, 1999. A similar foamed glass article is disclosed in U.S. Pat. No. 5,821,184, “Foamed Glass Article for Preparing Surfaces, Use Therefore and Method of Making Same” to Haines et al., which issued on Oct. 13, 1998. Another type of foamed glass article is disclosed in U.S. Pat. No. 5,928,773, “Foamed Glass Articles and Methods of Making Same and Methods of Controlling the PH of Same Within Specific Limits” to James C. Andersen, which issued on Jul. 27, 1999. Note that U.S. Pat. No. 5,972,817, U.S. Pat. No. 5,821,184, and U.S. Pat. No. 5,928,773 are incorporated herein by reference.

The foamed glass article disclosed in U.S. Pat. No. 5,972,817 and U.S. Pat. No. 5,821,184 comprises a foamed glass article formed in the shape of a block, disk or similar product and which is used to prepare surfaces by sanding, rubbing and scraping the same to clean, abrade, polish and so forth. U.S. Pat. No. 5,972,817 and U.S. Pat. No. 5,821,184 disclose a surface preparing means in the form of a foamed glass article having any desired specific shape, with the foamed glass article being derived from a starting mixture that comprises glass and generally 0.10-20.0% by weight of at least one non-carbon/sulfate based foaming agent. The invention disclosed in U.S. Pat. No. 5,972,817 and U.S. Pat. No. 5,821,184 provides for the use of a foamed glass article as a surface preparing means, and a method of making foamed glass as a surface preparing means, including the steps of providing powdered or ground glass, mixing at least one non-carbon/sulfate based foaming agent with the powdered glass to form a mixture, placing the mixture on a surface, such as a belt, plate, or in a mold, heating the mixture on the belt or in the mold so that the mixture sinters and subsequently foams, and annealing the foamed mixture by cooling the same to room temperature to form a foamed glass product.

The glass can be virgin glass or waste glass. The term “waste glass” generally refers to any waste glass that is waste or scrap, either from a pre-consumer manufacturing operation, such as window plate manufacturing, glass bottle manufacturing, light bulb manufacturing, glass bead manufacturing, and the like, or post-consumer waste glass, such as bottles collected by a public or private recycling operation. Such recycled or otherwise recovered glass can include soda lime glass, borosilicate glass, alumino silicate glass, and recycled foamed glass. The glass can be utilized in powdered or otherwise pulverulent form and has an average particle size distribution that ranges from 1-500μ. Although, as indicated, any glass can be used, to ensure consistency of the glass, clean glass or even virgin glass is preferred.

Although the starting mixture is intended to cover a range of powdered or ground glass and 0.10-20% by weight of foaming agent, it is presently contemplated that a preferred range will be 0.5-5.0% by weight of foaming agent. In addition, pursuant to a preferred heating step, the mixture of powdered glass and foaming agent is first heated to a sintering temperature and subsequently the temperature is increased to effect foaming. For example, the mixture can first be heated to a temperature of about 1250° F. with this temperature being maintained for a given period of time, such as for one hour; the temperature can then be increased to a range of 1274-1700° F. to effect foaming. Annealing of the foamed mixture can either comprise a gradual cooling to room temperature, or, pursuant to a preferred embodiment, can comprise the steps of first rapidly cooling the foamed mixture to a temperature below a foaming temperature, and then slowly cooling the foamed mixture to room temperature. Any glassy skin or crust that is formed on the resulting product can be removed, at least from abrasive surfaces, such as by cutting or planing using any suitable means.

The starting mixture of powdered glass and foaming agent can comprise 69.9-99.9% by weight glass and 0.10-20% by weight foaming agent including mixtures of two or more foaming agents; in addition, 0-30.0% by weight of additional abrasive material can be added to the mixture prior to placing such a mixture in a mold. It should be noted that although the mixture can be placed on a belt or plate, it is presently preferred to use molds. A single larger mold or a plurality of smaller discrete molds can be provided. The smaller molds can actually have a geometry that is substantially the same as the desired final geometry of the foamed glass articles. If a larger mold is used, the product produced can be cut to the desired size and shape. In addition, placing one or more mounds thereof in the mold or molds, possibly forming one or more rows of such mounds, can place the mixture in the mold or molds.

Although calcium carbonate appears to be a particularly expedient foaming agent, a large variety of non-carbon/sulfate based foaming agents can be used. Examples of such foaming agents include magnesium carbonate, sodium carbonate, strontium carbonate, lithium carbonate, barium carbonate, sugar, urea, water, and mixtures thereof. An additional abrasive material can optionally be added to the mixture to vary the abrasive quality of the final foamed glass article and can be selected from a wide variety of common abrasive grit materials, such as, but not limited to, sand, aluminum oxide, silicon carbide, garnet, and mixtures thereof.

Based on the foregoing, the present inventor has concluded that a need exists to utilize foamed glass articles and structures for environmental remediation and oil filtration. The present inventor is unaware of any known disclosure or suggestion for the use of foamed waste or virgin glass, so-called white foamed glass, as an environmental remediation or filtering device.

### BRIEF SUMMARY OF THE INVENTION

The following summary of the invention is provided to facilitate an understanding of some of the innovative features unique to the present invention, and is not intended to be a full description. A full appreciation of the various aspects of the invention can be gained by taking the entire specification, claims, drawings, and abstract as a whole.

It is therefore one aspect of the present invention to provide a foamed glass article for use in environmental remediation, such as for example, cleaning of oil spills on water or on land.

It is therefore another aspect of the present invention to provide a foamed glass article for use in filtration of viscous fluids such as oil and liquids such as water.

It is yet an additional aspect of the present invention to provide a foamed glass article in the shape of a block for use in environmental remediation and/or oil filtration.

It is yet an additional aspect of the present invention to provide a foamed glass article in the shape of a disk for use in environmental remediation and/or oil filtration.

The above and other aspects of the invention can be achieved as is now described. Methods, systems and devices for environmental remediation utilizing a foamed glass article are disclosed herein. A foamed glass article is provided, which can come into contact with a viscous fluid, such as, for example oil or another petroleum based viscous product. The foamed glass article can absorb the viscous fluid (e.g., oil or other petroleum products) in order to prevent further environmental contamination thereof by the viscous fluid. The foamed glass article can be formed in the shape of a block, a disk or a number of other shapes, such as spherical or pyramidal shapes. The foamed glass article can be formed from a starting mixture that comprises glass and at least one foaming agent. Such glass may comprise powdered glass, virgin glass, waste glass and/or a combination thereof. The foaming agent utilized to form the foamed glass article can comprise a non-sulfur based foaming agent and/or a non-carbon/sulfate based foaming agent. A typical foamed glass article in the shape of a glass, for example, can absorb approximately thirty times its weight in water within a short period of time (e.g., 5 to 10 minutes). Such a block can absorb oil form water within minutes and can be utilized to clean up (i.e., remediate) oil spills in the oceans or seas or other pathways. Additionally, such a block can be utilized to filter oil. If the block becomes wet, after the oil has been absorbed, the oil or other viscous fluid will remain in the block and the water will then drain out of the block.

### BRIEF DESCRIPTION OF THE DRAWINGS

The accompanying figures, in which like reference numerals refer to identical or functionally-similar elements throughout the separate views and which are incorporated in and form part of the specification, further illustrate the present invention and, together with the detailed description of the invention, serve to explain the principles of the present invention.

FIG. 1 illustrates a prior art pictorial drawing of a large mold in which rows of mounds of starting mixture are placed;

FIG. 2 depicts a pictorial diagram of a foamed glass article in the form of a block for environmental remediation at Time 1, in accordance with a preferred embodiment of the present invention;

FIG. 3 illustrates a pictorial diagram of a foamed glass article in the form of a block for environmental remediation at Time 2, in accordance with a preferred embodiment of the present invention;

FIG. 4 depicts a pictorial diagram of a foamed glass article in the form of a disc utilized in a fluid delivery system for fluid filtration, in accordance with an alternative embodiment of the present invention;

FIG. 5 illustrates a side pictorial view of a foamed glass article in the form of a block for removing oil from a surface at Time 1, in accordance with an alternative embodiment of the present invention;

FIG. 6 depicts a side pictorial view of a foamed glass article in the form of a block for removing oil from a surface at Time 2, in accordance with an alternative embodiment of the present invention;

FIG. 7 illustrates a pictorial diagram illustrating a plurality of foamed glass articles for use in cleaning an oil spill on water, in accordance with an alternative embodiment of the present invention; and

FIG. 8 depicts a pictorial diagram illustrating a plurality of foamed glass articles for use in cleaning an oil spill on water, in accordance with an alternative embodiment of the present invention.

### DETAILED DESCRIPTION OF THE INVENTION

The particular values and configurations discussed in these non-limiting examples can be varied and are cited merely to illustrate an embodiment of the present invention and are not intended to limit the scope of the invention.

The present inventor has discovered that foamed glass made with at least one non-carbon/sulfate based foaming agent provides a universal product for environmental remediation and/or oil filtration.

The foamed glass article of the present invention can be utilized in block or disk form. Although such blocks can have any desired and convenient shape, the blocks themselves may have a specific geometry. The foamed glass article described can be used for use in oil spills on land or on water. A block formed from the foamed glass article described herein for use in environmental remediation and/or oil filtration can be referred to as a “sponge block.” A sponge block can absorb approximately thirty times its weight in water or other liquid within an approximately five to ten minute period. The sponge block can absorb oil from water within minutes and can be utilized to clean up oil spills in the oceans or seas or lakes or to filter oil, as will be illustrated herein. If the block becomes wet, after the oil has been absorbed, the oil will remain within the block, but the water will filter through the block. The block can also be utilized to scrub oil spills from concrete or tar. As utilized herein, the term “block” and “sponge block” can be utilized interchangeably to refer generally to a foamed glass article for use in environmental remediation and/or fluid filtration.

The foamed glass product is non-toxic, long lasting, and does not generate fine air-borne dust. The foamed glass product will work wet or under water without any loss of performance. The foamed glass product has a far different cellular structure than does so-called black foamed glass, which is made with a carbon/sulfate-based foaming agent. In particular, in contrast to the closed and regular cellular structure of black foamed glass, which encloses noxious gas, the inventive foamed glass is first of all formed, for example, by expanding and escaping carbon dioxide gas, rather than sulfur dioxide and/or hydrogen sulfide gas. Furthermore, the cell structure of the foamed glass product described herein is open, interconnected, and irregular, allowing ambient atmospheric gasses to penetrate the cells.

A distinct and surprising advantage of the inventive foamed glass is the fact that it is an extremely economical product. This is particularly surprising and unexpected due to the experience in the past with black foamed glass, which is very expensive to produce. The present invention provides for the use of a far less expensive glass, especially when waste glass is used, which at the same time has a significant positive environmental impact, especially since the market for waste glass is very limited, being almost nonexistent for mixed color waste glass; thus, presently a large percentage of waste glass ends up in landfills.

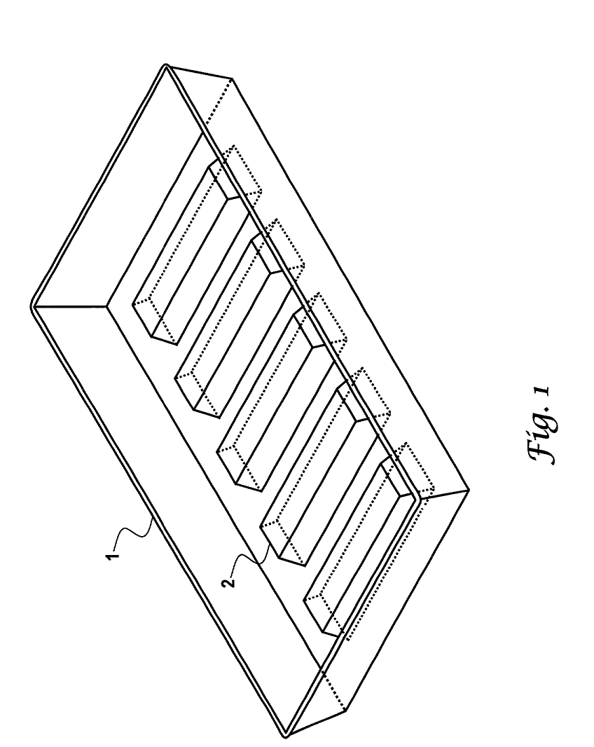

Prior to providing specific examples, the following is a more general discussion concerning production of the foamed glass product described herein for use in environmental remediation and oil filtration. As indicated previously, powdered virgin glass or recycled waste glass can be mixed with finely ground non-carbon/sulfate based foaming agent typically in the average range of about 80 to minus (i.e. any particles smaller than this will pass through) 325 mesh. Additional abrasive or refractory material can also be added to the starting mixture to vary or enhance the abrasive characteristic of the final product. The resulting dry mixture can be placed into a mold, such as the mold 1 of FIG. 1.

FIG. 1 illustrates a prior art pictorial drawing of a large mold in which rows of mounds of starting mixture are placed. The mixture can be expediently placed into the mold 1 in the form of several rows 2 of the mixture. These mounds or piles of mixture typically have a natural angle of repose of about 15 to 50 degrees. Even greater angles to the horizontal can be achieved by compressing the dry mixture. Depositing the mixture into shaped mounds, with or without compacting, and in the form of discrete piles or rows, helps to eliminate the folds and voids that typically appear when mixtures of this type are foamed as flattened beds of powder.

The mold 1 can be made of steel, ceramic, or ceramic fiber, and is expediently in the shape of a frustum in order to facilitate easy release of the final foamed glass product. In addition, the internal surfaces of the mold can be coated with a soft refractory release agent to further facilitate separation of the foam glass product from the mold.

One or more molds with the mixture therein can be placed into a furnace for either a batch or continuous foaming process. The mixture is then heated in order to sinter and foam the mixture and thereby produce the foamed glass product having a desired density, pore size and hardness. As the powdered mixture is heated to above the softening point of glass, approximately 1050° F., the mixture begins to sinter. The division of the powdered mixture into rows or mounds allows the glass to absorb heat more rapidly and to therefore foam faster by reducing the ability of the foaming glass to insulate itself. At approximately 1058° F., the calcium carbonate, if calcium carbonate has been used as the foaming agent, begins to react with some of the silicon dioxide in the glass to produce carbon dioxide gas. Carbon dioxide is also formed by any remaining calcium carbonate once the mixture reaches 1274° F., above which calcium carbonate breaks down into calcium oxide and carbon dioxide gas. The carbon dioxide is primarily responsible for the formation of cells and pores in the softened glass mass as the carbon dioxide expands. The mixture in the mold is held for a period of time at a peak foaming temperature of, for example, between 1274-1700° F., or even higher, depending on the properties that are desired. By adjusting the process temperatures and times, the density and hardness as well as other properties can be closely controlled.

As the furnace reaches foaming temperatures, each mass of foaming glass, originating from one of the discrete rows or mounds, foams until it comes into contact and fuses with its neighbors. The fused mass of foaming glass then expands to conform to the shape of the walls of the mold, filling all of the corners. The shapes and sizes of the initial mounds of mixture are very important and are determined with the anticipation that the foaming mixture exactly fills the mold. After the glass is foamed to the desired density and pore structure, the temperature of the furnace is rapidly reduced to halt foaming of the glass. When the exterior of the foamed glass in the mold has rigidified sufficiently, the mass of foamed glass cooled in the mold or can be removed from the mold and placed into a lehr for annealing. The temperature of the lehr is slowly lowered from the softening temperature of the glass to ambient temperature to anneal the block of foamed glass. Once cooled, any skin or crust can be cut off of the foamed glass product, and the product can be cut into a variety of desired shapes.

The following examples illustrate the wide variety of compositions and applications for the inventive foamed glass articles.

### EXAMPLE 1

To produce a block for environmental remediation and/or oil filtration, 13.68 g (2.4%) calcium carbonate, minus 200 mesh, 442.32 g (77.6%) recycled float glass ground to minus 140 mesh, and 114 g (20%) sand, 60 to 100 mesh, can be mixed thoroughly together. The resulting mixture is then placed into a stainless steel mold having inside dimensions of 4¼ inches × 4 inches × 8¼ inches. The mold is generally covered with an approximately ½-inch stainless steel plate. The mold with the mixture therein can be fired to 1250° F. to sinter for 60 minutes. The temperature can then be raised to 1450° F. to foam for 30 minutes. The foamed glass in the mold can be annealed by cooling slowly to room temperature over 120 minutes. The cooled block of foamed glass can be removed from the mold, and the outer layer of crust can be removed with a band saw to expose the abrasive cells. The resulting block can have a density of 13.9 pounds per cubic foot and a pore size distribution ranging from about 0.5 to 2 mm. The resulting block can possess final dimensions of 4 inches × 3.75 inches × 8 inches (it is contemplated that grill cleaning blocks can range in size from 1½ inches × 3¾ inches × 4 inches to 2½ inches × 3½ inches × 6 inches to 4 inches × 4 inches × 8 inches). The resulting block generally possesses no odor, can be white to light gray in color, and generally possesses open, interconnected cells.

### EXAMPLE 2

A further grill cleaning block having no sand or embedded abrasives can be formed by a procedure similar to that of Example 1 by utilizing 17.1 g (3%) calcium carbonate, minus 200 mesh, and 552.9 g (97%) recycled container glass, minus 325 mesh. The foaming temperature can be 1400° F. for 45 minutes. The resulting density can be 7.2 pounds per cubic foot, with the resulting material having a pore size distribution ranging from about 1 to 3 mm.

### EXAMPLE 3

To prepare a block for use in environmental remediation and/or oil filtration, a procedure similar to that of Example 1 can be utilized by mixing together 564.3 g (98.5%) recycled container glass, minus 325 mesh, and 5.7 g (1.5%) calcium carbonate, minus 200 mesh. The foaming temperature can be 1360° F. for 60 minutes. The resulting density can be 17.6 pounds per cubic foot, with a pore size distribution ranging from about 0.05 to 0.2 mm. The resulting block may be pure white in color due to the use of clear container glass. The resulting block can also be cut into smaller blocks of a size suitable for particular environmental remediation purposes, such as cleaning oil from a driveway, and may posses final dimensions of 2 inches × 2 inches × 4 inches (in this case, it is contemplated that such blocks can range in size from 1 inch × 1½ inches × 6 inches to 2 inches × 2½ inches × 4 inches to 3 inches × 4 inches × 1½ inches). The cut blocks can be mounted onto a handle by fixing the handle into a hole drilled into each block.

### EXAMPLE 4

Another block for environmental remediation and/or oil filtration can be prepared in a procedure similar to that of Example 1 by mixing together 569.4 g (99.9%) recycled container glass, minus 325 mesh, and 0.6 g (0.1%) calcium carbonate, minus 325 mesh. The foaming temperature can be 1425° for 25 minutes. The density of the resulting material can be 15.3 pounds per cubic foot, with a pore size distribution ranging from approximately 0.01 to 0.1 mm. Again, the resulting block can be cut into smaller blocks.

### EXAMPLE 4A

To produce a further cleaner block for environmental remediation and/or oil filtration, 44 g (2%) calcium carbonate minus 200 mesh, 5.5 g (0.025%) sodium carbonate minus 200 mesh, 5.5 g (0.025%) magnesium carbonate minus 200 mesh, 2.15 kg (97.95%) recycled float glass minus 200 mesh can be mixed thoroughly together. The resulting mixture can be placed onto a ceramic mold having inside dimensions of 18 inches × 10½ inches × 6 inches. The mold can be covered with a ceramic lid ⅝ inches thick. The temperature can then be raised to 1250° F. to sinter for 75 minutes, the temperature was then raised to 1320° F. to foam for 40 minutes. The foamed glass in the mold can be annealed by cooling slowly to room temperature over 120 minutes. The resulting block may have a thickness of 3 inches. The cooled block of foamed glass can be removed from the mold, and the outer layer of crust can be removed with a band saw to expose the abrasive cells. The resulting block may have a density of approximately 14.9 pounds per cubic foot and a pore size ranging from about 0.5 to 1.5 mm. The resulting cut block may possess final dimensions of 2 inches × 2 inches × 4 inches (it is contemplated that such blocks can range in size from 1 inch × 1½ inches × 6 inches to 2 inches × 2½ inches × 4 inches to 2 inches × 3 inches × 4 inches). The cut blocks can be mounted onto a handle by fixing the handle into a hole drilled into each block.

### EXAMPLE 5

A block for environmental remediation and/or oil filtration can be produced in a procedure similar to that of Example 1 by mixing together 564.3 g (99%) recycled container glass, minus 60 mesh and 5.7 g (1%) calcium carbonate, minus 200 mesh. The foaming temperature can be 1500° F. for 20 minutes. The resulting material can possess a density of 24.3 pounds per cubic foot and a pore size distribution ranging from about 0.1 to 0.5 mm. The resulting block can be cut into convenient-to-hold blocks having final dimensions of 4 inches × 3.75 inches × 2 inches (it is contemplated that such blocks can have a size ranging from 4 inches × 4½ inches × 1½ inches to 2½ inches × 3½ inches × 6 inches to 3 inches × 2 inches × 8 inches). The color of the resulting block may be pale yellow to tan due to the use of amber container glass (it should be noted that any container glass or plate glass is potentially suitable for this purpose).

### EXAMPLE 6

Another block for environmental remediation and/or oil filtration can be produced in a procedure similar to that of Example 1 by mixing together 552.9 g (97%) recycled float glass, minus 140 mesh, and 17.1 g (3%) calcium carbonate, minus 200 mesh. The foaming temperature can be 1360° F. for approximately 60 minutes. The resulting material may possess a density of approximately 19.8 pounds per cubic foot, and a pore size distribution ranging from approximately 0.05 to 0.2 mm. Again, the resulting block can be cut into convenient-to-hold blocks.

### EXAMPLE 7

A further block for environmental remediation and/or oil filtration cab be produced in a procedure similar to that of Example 1 by mixing together 552.9 g (97%) recycled float glass, minus 200 mesh, and 17.1 g (3%) calcium carbonate, minus 200 mesh. The foaming temperature can be 1500° for 20 minutes. The resulting material may possess a density of 11.2 pounds per cubic foot, and a pore size distribution ranging from approximately 0.5 to 1.5 mm. The resulting block can be cut into convenient-to-hold blocks having final dimensions of approximately 4 inches × 3.75 inches × 2 inches.

### EXAMPLE 8

Another block for environmental remediation and/or oil filtration can be produced by mixing together 535.8 g (94%) recycled float glass, minus 140 mesh, and 34.2 g (6%) calcium carbonate, minus 200 mesh. The foaming temperature can be 1500° F. for 20 minutes. The resulting material may have a density of approximately 15.6 pounds per cubic foot, and a pore size distribution ranging from approximately 0.5 to 1.0 mm. Again, the resulting block can be cut into convenient-to-hold blocks.

### EXAMPLE 9

Another block for environmental remediation and/or oil filtration can be prepared in a procedure similar to that of Example 1 by mixing together 13.68 g (2.4%) calcium carbonate, minus 200 mesh, 442.32 (77.6%) recycled container glass ground to minus 60 mesh, and 114 g (20%) sand, 60 to 100 mesh. The foaming temperature can be 1500° F. for approximately 20 minutes. The resulting material may have a density of approximately 27.8 pounds per cubic foot, and a pore size distribution ranging from approximately 1 to 3 mm. The resulting block can again be cut into blocks of a size convenient to hold by hand. The resulting block may be pale yellow to tan in color due to the use of amber container glass.

### EXAMPLE 10

Another block for environmental remediation and/or oil filtration can be produced in a procedure similar to that of Example 1 by mixing together 57.0 g (10%) calcium carbonate, minus 200 mesh, and 513 (90%) recycled container glass ground to minus 325 mesh. The foaming temperature can be 1600° F. for 15 minutes. The resulting material may have a density of approximately 17.2 pounds per cubic foot, and a pore size distribution ranging from about 2 to 4 mm. The resulting block can again be cut into blocks of a size convenient to hold by hand.

### EXAMPLE 11

In order to produce a disk for use in environmental remediation and/or oil filtration, 15.81 kg (93%) of minus 140 mesh recycled float glass can be mixed together with 1.19 kg (7%) of minus 200-mesh calcium carbonate. The mixture can be placed in a mold having a dimension of 22 inches × 46 inches × 5 inches and the mold can be covered with a stainless steel lid. The mold and mixture can be sintered at 1250° F. for 60 minutes, whereupon the temperature can be raised to foam at 1500° F. for 40 minutes. The temperature can then be lowered slowly to room temperature over 360 minutes. The resulting mass of foamed glass may have dimensions of approximately 22 inches × 46 inches × 6 inches (the extra inch was due to the lifting of the lid by the expanding foam). The resulting material may possess a density of approximately 19.5 pounds per cubic foot, and a pore size distribution ranging from approximately 1 to 2.4 mm. The resulting mass of foamed glass can be cut into multiple blocks, which are then cut into multiple cylindrical shapes having 5-inch diameters, which are then sliced into disks 2 inches thick; the cuts made with a band saw. It is contemplated that such disks may range in size from approximately 4-6 inches in diameter to 1 to 2 inches thick.

### EXAMPLE 12

Another disk for environmental remediation and/or oil filtration uses can be produced in a procedure similar to that of Example 11 by mixing together 16.32 kg (96%) of minus 325 mesh recycled container glass and 0.68 kg (4%) of minus 200 mesh calcium carbonate. The foaming temperature can be 1450° F. for 60 minutes. The resulting material may have a density of approximately 14.8 pounds per cubic foot and a pore size distribution ranging from about 0.5 to 1.5 mm. The resulting mass of foamed glass can again be cut into two-inch thick disks having approximately a 5-inch diameter.

### EXAMPLE 13

A block for use in environmental remediation (e.g., oil spill remediation) and/or oil filtration can be formed by a procedure similar to that of Example 11 by mixing together 16.49 kg (97%) of minus 140 mesh float glass and 0.51 kg (3%) of minus 200 mesh calcium carbonate. The foaming temperature can be 1500° F. for 40 minutes. The resulting foamed glass material may have a density of approximately 11.9 pounds per cubic foot and a pore size distribution of about 1.2 to 2.8 mm. The resulting mass of foamed glass can be cut into multiple blocks, which are then cut into blocks having dimensions of approximately 4 inches × 4 inches × 2.5 inches (it is contemplated that such blocks could range in size from 1½ inches × 4¼ inches × 4½ inches to 2 inches × 3¾ inches × 7¼ inches). Such a block may be particularly well suited for remediation of oil spills from concrete surfaces, such as parking lots or driveways.

### EXAMPLE 14

Another block for use in environmental remediation and/or oil filtration can be produced in a procedure similar to that of Example 11 by mixing together 16.49 kg (97%) of minus 60 mesh recycled container glass and 0.51 kg (3%) of minus 200 mesh calcium carbonate. The foaming temperature can be 1500° F. for 40 minutes. The resulting material may be similar to that of Example 13 except that it may possess a density of approximately 18.3 pounds per cubic foot and a pore size distribution ranging from about 2 to 4 mm. Such blocks can be prepared in a manner similar to that described in Example 13, with the blocks having a pale yellow to tan color due to the use of amber container glass.

### EXAMPLE 15

To produce another type of block for environmental remediation and/or oil filtration, a procedure similar to that of Example 1 can be utilized by thoroughly mixing together 541.5 g (95%) recycled float glass, minus 200 mesh, and 28.5 g (5%) of calcium carbonate, minus 200 mesh. The foaming temperature can be 1400° F. for 45 minutes. The resulting material may have a density of 16.6 pounds per cubic foot, and a pore size distribution ranging from about 0.05 to 0.2 mm. The resulting block can be cut into smaller blocks of a suitable sizes, and may possess final dimensions of approximately 4 inches × 4 inches × 3 inches (it is contemplated that blocks can range in size from 3½ inches × 4 inches × 3 inches to 4 inches 4 inches × 1½ inches to 4 inches × 4 inches × 8 inches).

### EXAMPLE 16

Another block can be produced in a procedure similar to that of Example 1 by mixing together 552.9 g (97%) recycled container glass, minus 325 mesh, and 17.1 g (3%) of magnesium carbonate, minus 200 mesh. The foaming temperature can be 1400° F. for 45 minutes. The resulting material may have a density of 28.6 pounds per cubic foot, and a pore size distribution ranging from 0.01 to 0.2 mm. The resulting block can again be cut into smaller blocks of 4 inches × 4 inches × 3 inches.

### EXAMPLE 17

An additional block can be produced by a procedure similar to that of Example 1 by mixing together 456 g (80%) recycled container glass, minus 325 mesh, and 114 g (20%) of calcium carbonate, minus 325 mesh. The foaming temperature can be 1700° F. for 15 minutes. The resulting material may have a density of 42.6 pounds per cubic foot and a pore size distribution ranging from approximately 0.01 to 0.1 mm.

### EXAMPLE 18

The following example provides some additional detail concerning the expedient mounding of the foamable mixture. To produce a block of foamed glass material for use in environmental remediation and/or oil filtration, for example, 12 kg of a foamable glass mixture can be prepared by thoroughly mixing together for 20 minutes in a mechanical mixer 2.4% by weight calcium carbonate powder (100% of which passes through a 200 mesh screen), 77.6% by weight recycled or virgin glass (100% of which passes through a 325 mesh screen), and 20% by weight common sand (100% of which passes through a 40 mesh screen but which does not pass through an 80 mesh screen). A ¼ inch stainless steel plate having a dimension of 20 inches × 26 inches can be coated with a thin slurry of talc and alumina as agents to prevent sticking. A stainless steel mold can be coated with the same slurry.

The mold can have the shape of a frustum and may be open at the base. The base dimensions can be 20 inches × 26 inches, and the peak dimensions can be 19 inches × 26 inches. The mold itself can be 6 inches deep. The foamable mixture can be divided into four equal portions of 3 kg each, and each portion is generally placed on the 20 inch × 26 inch plate in a row such that it possesses base dimensions of 4.5 inches × 16 inches. The four rows can be evenly spaced 2 inches apart. The rows, which may run parallel to the 26 inches dimension of the plate, can be spaced 1 inch away from the edge of the plate. The ends of the rows can be placed 2 inches away from the edges of the plate having the 20-inch dimensions.

Each row may have a trapezoidal cross-section the base of which is generally 4.5 inches and the top of which can be 3.5 inches, with a height of approximately 3 inches. Each portion can be compacted into the above shape, and the bulk density of the powder after being compacted may be 72 pounds per cubic foot. The frustum shaped lid can be lowered onto the plate that supported the mounds of foamable mixture, whereupon the entire assembly can be placed into a furnace. The furnace can be rapidly heated to 1250° F. and can be held there for one hour to allow the foamable mixture to sinter and absorb heat evenly.

The temperature can then be increased to 1500° F. and held there for 60 minutes. The mounds of powder will then foam, fuse, and fill the mold during this process. The temperature can be then rapidly lowered to 1050° F. and is generally held there for 15 minutes to halt the foaming process and to solidify the outside skin of the mass of foamed glass. The frustum shaped portion of the mold then be removed from the mass of solidified foamed glass. The block of foamed glass can then be placed in an annealing lehr, which slowly cools the foamed glass from 1050° F. to ambient temperature. The finished and cooled block of foamed glass can then be planed and trimmed to remove the glassy skin and traces of release agent. The finished cut block of foamed glass generally can have dimensions of 18 inches × 24 inches × 4 inches, a density of 19.3 pounds per cubic foot, and a pore size distribution ranging from about 2.0 to 5.0 mm. The finished block of foamed glass can then be cut into a variety of regular shapes for utilization in environmental remediation and/or oil filtration.

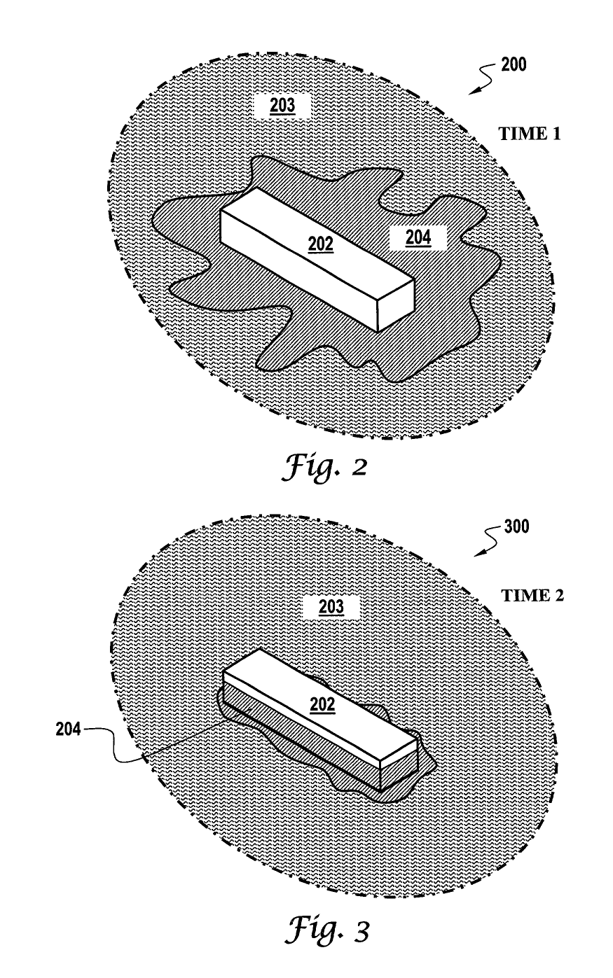

FIG. 2 depicts a pictorial diagram 200 of a foamed glass article in the form of a block 202 for environmental remediation at Time 1, in accordance with a preferred embodiment of the present invention. As indicated in FIG. 2, oil 204 is present on the surface of water 203. Those skilled in the art can appreciate that oil 204 may have come to rest on the surface of water 203 as the result of an oil spill. For example, an oil tanker may have leaked oil 204 as a result of an accident. Block 202 thus comprises a sponge block, as disclosed herein, which is placed on and oil 204 in order to absorb oil 204 and thereby clean up the associated oil spill. Note that in FIGS. 2 and 3, like or identical parts or elements are indicated by identical reference numerals.

FIG. 3 illustrates a pictorial diagram 300 of the foamed glass article of FIG. 3 in the form of block 202 for environmental remediation at Time 2, in accordance with a preferred embodiment of the present invention. At Time 2, block 202 has absorbed oil 204, as indicated in FIG. 3. Block 202 (i.e., a sponge block) can absorb thirty times its weight in water or liquid, within a five to ten minutes period. It can be appreciated by those skilled in the art that block 202 may not necessarily float on water 203, unless block 202 is formed with the appropriate density. If not, block 202, may be connected to rope like devices made of plastic or rubber or another suitable material which are attached to a boat which pulls block 202 through the oil 204 during remediation. Thus, a boat through water 203 may tow one or more blocks 202 during environmental remediation operations. Alternatively, one or more blocks 202 may be supported by buoyant platforms, which in turn are towed by a boat through water 203 during an environmental remediation operation (e.g., remediating an oil spill).

A number of blocks 202 may be utilized in association with one another to remediate particularly tough oil spills. After the oil has been absorbed by block 202, as indicated at Time 2 in FIG. 3, the oil 204 will remain within block 202, but any water absorbed by block 202 will come out of block 202. Although block 202 is illustrated as a block structure in FIGS. 2 and 3, those skilled in the art can appreciate that block 202 may possess another shape, such as, for example, a disk or a sphere. Thus, the shape or size of block 202 is not considered a limiting feature of the present invention, but merely represents but one possible embodiment in which the present invention can be implemented.

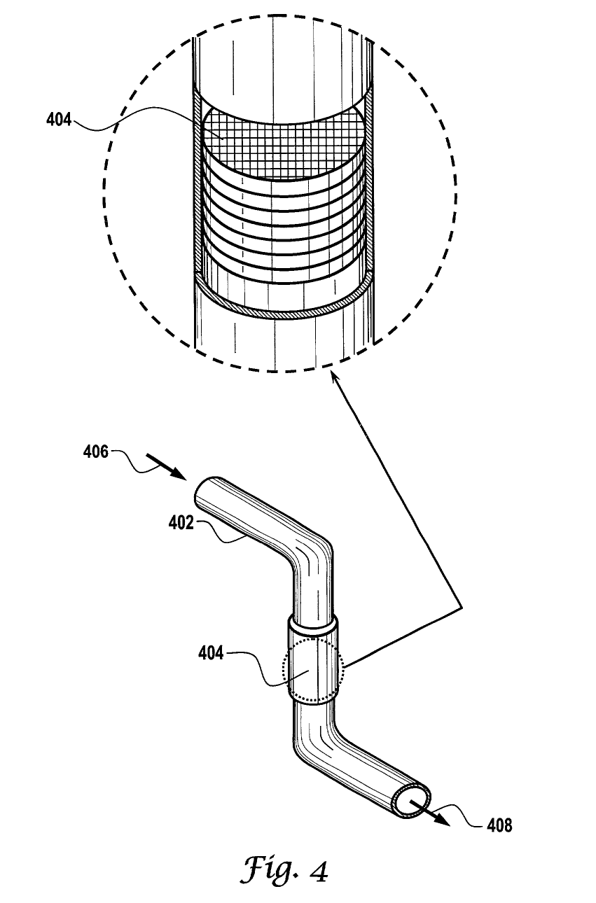

FIG. 4 depicts a pictorial diagram 400 of a foamed glass article in the form of a disk 404 for oil filtration, in accordance with an alternative embodiment of the present invention. Disk 404 is located within a pipe 402 through which oil (or another viscous fluid) and water (or another fluid) may flow, as indicated by arrows 406 and 408. Assume, for example, that oil and water are flowing together through pipe 402 and it is desired to filter the water from the oil or vice versa. The oil and water are absorbed by disk 404. The oil and water can both be absorbed by disk 404, but the oil will remain within disk 404. The water will come out, however, of disk 404. Thus, disk 404 comprises a foamed glass article in accordance with the present invention for use as an oil and/or water filter.

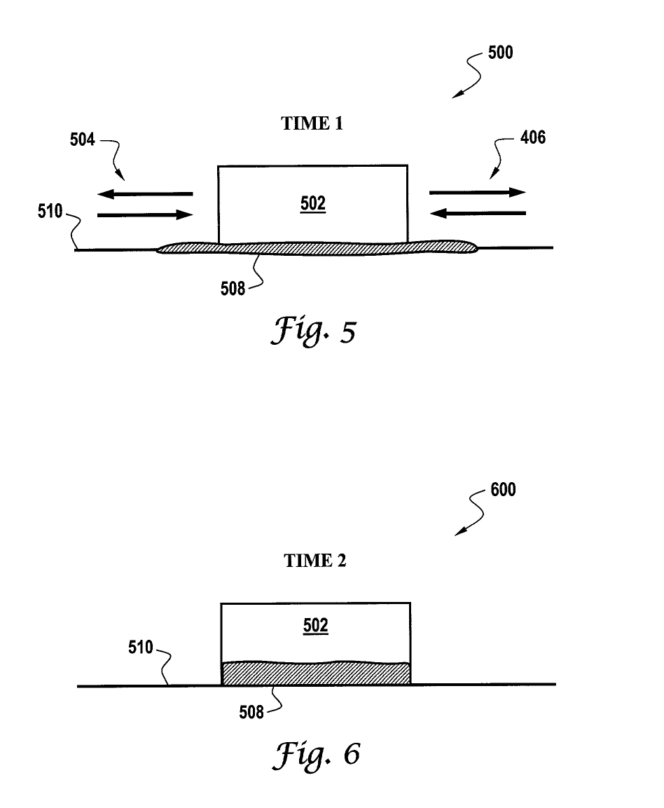

FIG. 5 illustrates a side pictorial view 500 of a foamed glass article in the form of a block 502 for removing oil from a surface at Time 1, in accordance with an alternative embodiment of the present invention. Block 502 can be positioned over a blotch of oil 508 present on a surface 510 such as a concrete surface of a parking lot of home driveway. Block 502, which is analogous to block 202 of FIGS. 2 and 3, can be utilized in a rubbing or scraping motion as indicated by arrows 504 and 506 to both scrape and absorb oil 508 from surface 510. FIG. 6 depicts a side pictorial view of block 502 for removing oil from a surface at Time 2, in accordance with an alternative embodiment of the present invention. As indicated at Time 2, oil 508 has been absorbed by block 502. Note that block 502 generally comprises a sponge block, which was defined earlier as comprising a foamed glass article formed in the shape of a block or another shape, such as, for example, a disk or sphere.

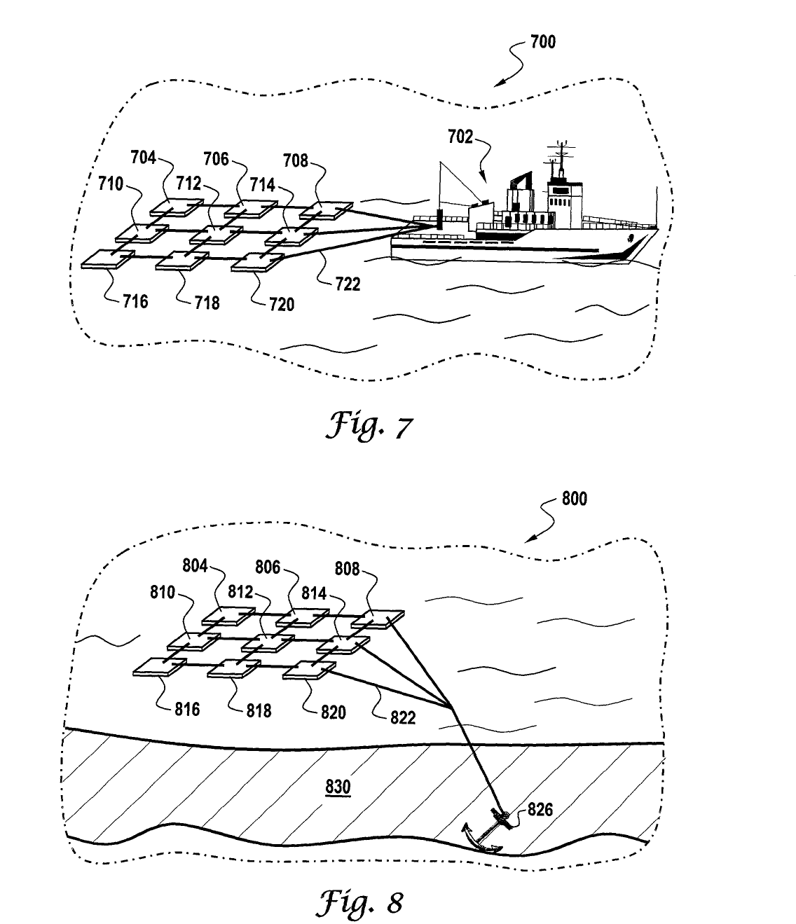

FIG. 7 illustrates a pictorial diagram 700 illustrating a plurality of foamed glass articles 704, 706, 708, 710, 712, 714, 716, 718 and 720 for use in cleaning an oil spill on water, in accordance with an alternative embodiment of the present invention. Each foamed glass article 704, 706, 708, 710, 712, 714, 716, 718 and 720 is formed in the shape of a buoyant block which can float upon water, as illustrated in FIG. 7. The foamed glass articles 704, 706, 708, 710, 712, 714, 716, 718 and 720 can be tied or connected to one another and further towed via a tow-line 722 by a boat 702 (e.g., a barge). Note that each foamed glass article 704, 706, 708, 710, 712, 714, 716, 718 and 720 is generally analogous to the block 202 illustrated in FIGS. 2 and 3. Although a particular number of foamed glass articles 704, 706, 708, 710, 712, 714, 716, 718 and 720 are illustrated in FIG. 7 it can be appreciated by those skilled in the art that more or fewer foamed glass articles may be required, depending on the nature of a particular oil spill requiring clean up through oil absorption by such foamed glass articles.

FIG. 8 depicts a pictorial diagram 800 illustrating a plurality of foamed glass articles 804, 806, 808, 810, 812, 814, 816, 818, and 820 for use in cleaning an oil spill on water, in accordance with an alternative embodiment of the present invention. The foamed glass articles 804, 806, 808, 810, 812, 814, 816, 818, and 820 of FIG. 8 are generally analogous the foamed glass articles 704, 706, 708, 710, 712, 714, 716, 718 and 720 of FIG. 7, the difference being that instead of being tied to a boat 702, the plurality of foamed glass articles depicted in FIG. 8 can be tied by one or more connecting lines 822 to an anchor 826 which sits at the bottom of an ocean, lake, river, or sea floor. Note that area 830 in FIG. 8 generally indicates an area below the surface of the water. Those skilled in the art can appreciate that in a particularly disastrous oil spill, a number of groups of such foamed glass articles can be placed at various locations about an oil spill in order to enhance environmental remediation operations thereof.

The embodiments and examples set forth herein are presented to best explain the present invention and its practical application and to thereby enable those skilled in the art to make and utilize the invention. Those skilled in the art, however, will recognize that the foregoing description and examples have been presented for the purpose of illustration and example only. Other variations and modifications of the present invention will be apparent to those of skill in the art, and it is the intent of the appended claims that such variations and modifications be covered. For example, although the present invention is disclosed in the context of environmental remediation and oil filtration, those skilled in the art can appreciate that the present invention may be adapted for use in remediating and/or filtering other types of viscous fluids. The description as set forth is not intended to be exhaustive or to limit the scope of the invention. Many modifications and variations are possible in light of the above teaching without departing from the spirit and scope of the following claims. It is contemplated that the use of the present invention can involve components having different characteristics. It is intended that the scope of the present invention be defined by the claims appended hereto, giving full cognizance to equivalents in all respects.

The embodiments of the invention in which an exclusive property or right is claimed are defined as follows. Having thus described the invention what is claimed is:

1. A method for environmental remediation utilizing a foamed glass article, said method comprising the steps of:
providing a foamed glass article;
contacting a viscous fluid with said foamed glass article; and
permitting said foamed glass article to absorb said viscous fluid in order to prevent contamination by said viscous fluid.

2. The method of claim 1 wherein said viscous fluid comprises oil from a water oil spill.

3. The method of claim 1 wherein said viscous fluid comprises oil from a surface oil spill.

4. The method of claim 1 wherein said foamed glass article has a shape of a block.

5. The method of claim 1 wherein said foamed glass article has a shape of a disk.

6. The method of claim 1 wherein said foamed glass article is formed from a starting mixture that comprises glass and at least one foaming agent.

7. The method of claim 6 wherein said glass comprises powdered glass.

8. The method of claim 6 wherein said glass comprises virgin glass.

9. The method of claim 6 wherein said glass comprises waste glass.

10. The method of claim 6 wherein said at least one foaming agent comprises a non-sulfur based foaming agent.

11. The method of claim wherein said at least one foaming agent comprises a non-carbon/sulfate based foaming agent.

12. A method for filtering fluid utilizing a foamed glass article, said method comprising the steps of:
providing a foamed glass article;
contacting a petroleum product and a fluid with said foamed glass article; and
permitting said foamed glass article to absorb said petroleum product and said fluid, such that said foamed glass article thereafter maintains said petroleum product within said foamed glass article while said fluid drains from said foamed glass article, thereby filtering said petroleum product from said fluid.

13. An environmental remediation apparatus, said apparatus comprising:
a foamed glass article, which comes into contact with a viscous fluid to thereby absorb said viscous fluid for environmental remediation thereof.

14. The apparatus of claim 13 wherein said viscous fluid comprises oil from a water oil spill.

15. The apparatus of claim 13 wherein said viscous fluid comprises oil from a surface oil spill.

16. The apparatus of claim 13 wherein said foamed glass article has a shape of a block.

17. The apparatus of claim 13 wherein said foamed glass article has a shape of a disk.

18. The apparatus of claim 13 wherein said foamed glass article is formed from a starting mixture that comprises glass and at least one foaming agent.

19. The apparatus of claim 18 wherein said glass comprises powdered glass.

20. The apparatus of claim 18 wherein said glass comprises virgin glass.

21. The apparatus of claim 18 wherein said glass comprises waste glass.

22. The apparatus of claim 18 wherein said at least one foaming agent comprises a non-sulfur based foaming agent.

23. The apparatus of claim 18 wherein said at least one foaming agent comprises a non-carbon/sulfate based foaming agent.

24. A filtering apparatus for filtering a fluid, said filtering apparatus comprising:
a foamed glass article, which contacts a petroleum product and a fluid and absorbs said petroleum product and said fluid, such that said foamed glass article thereafter maintains said petroleum product within said foamed glass article while said fluid drains from said foamed glass article, thereby filtering fluid of said petroleum product.
